(19) United States
(12) Patent Application Publication
(10) Pub. No.: US 2002/0059339 A1
(43) Pub. Date: May 16, 2002

(54) System for automated generation, testing and optimization of content, design and presentations

(76) Inventors: Justin V. McCormick, Lake Oswego, OR (US); Deborah L. Stewart, Wilsonville, OR (US)

Correspondence Address: STOEL RIVES LLP, 900 SW FIFTH AVENUE, SUITE 2600, PORTLAND, OR, 97204, US

(21) Appl. No.: 09/948,114

(22) Filed: Sep. 5, 2001

Related U.S. Application Data
(60) Provisional application No. 60/230,137, filed on Sep. 5, 2000.

(51) Int. Cl. G06F 17/00

(52) U.S. Cl. 707/500.1

(57) ABSTRACT

The present invention relates to an automated publishing system and a related method for generating documents that include both design elements and content elements. Documents within this context include any type of output that includes both design elements and content elements. The system tests output documents for a variety of factors by allowing for feedback from intended recipients of a document about the design and content of the document. The feedback may be in any form, such as a survey, or the number of recipients who respond to an advertisement, or the amount of time it takes the recipient to read a web page, for example. In this way the system correlates the response of recipients to the design and content elements of the document. Any correlations that are established through testing the response of recipients can be used as a basis for creating new documents.

### RELATED APPLICATIONS

This application is a continuation of U.S. Provisional Patent Application No. 60/230,137 filed Sep. 5, 2000, incorporated herein by reference.

### TECHNICAL FIELD

The present invention related to an automated publishing system for generating, testing and optimizing the design and content of documents.

Background of the Invention Typical prior art system for providing benefits to employees rely on a consistent look and feel to deliver information to employees. The systems provide personalized data, i.e. the system provides each user with their own financial or benefits data, but do not customize the way in which any data, whether personalized or generally applicable, is presented to the end user or recipient. The need remains for a system which can customize the look and content of information for particular users or particular classes of users. In addition prior system do not learn how to better present information to users based on user responses to prior documents.

While the prior art does teach system which can search a solution space thoses system are rigid and lack flexibility. For example, U.S. Pat. No. 5,867,397 of Koza et al. (Koza), incorporated by reference herein, discloses “[a]n automated design process and apparatus for use in designing complex structures, such as circuits, to satisfy prespecified design goals, using genetic operations.” Koza teaches in which a population of entities may be evolved to generate structures that may potentially satisfy predetermined design goals. The generated structures are evaluated in view of the design goals to determined if their behavior satisfies the design goal. Those structures more closely meeting the design goals are evolved further until a structure is generated that either meets the predetermined design goals or satisfies some other predetermined completion criteria.

U.S. Pat. No. 5,970,487 of Shackleford et al.(Shackleford), incorporated by reference herein, teaches “[a] multi-purpose non-problem-specific hardware-based framework for the execution of a genetic algorithm (GA) accelerates the execution speed of a GA through the implementation of hardware-based non-problem-specific functions of population memory, first and second chromosome registers, crossover module, mutation operator, and survival comparator.” Shackleford teaches that the hard-ware based framework may be modified to a problem-specific framework without changing the contents of the framework once a circuit is included for evaluating chromosomal data representing a potential problem solution.

Both of the above referenced patents and other prior art systems are dependent on a specific genetic algorithm implementation. The prior art does not teach using a plurality of genetic algorithms, in parallel, to search a solution space and determine if the system can more efficiently use different combinations of algorithms to more efficiently search a solution space. The need remains for a system that uses predictive techniques for determining the most efficient system architecture and search methods to apply to a given solution space.

### SUMMARY OF THE INVENTION

The present invention relates to an automated publishing system and a related method for generating documents that include both design elements and content elements. Documents within this context include any type of output that includes both design elements and content elements. Documents can include for example machine readable files, printed pieces of paper, or web pages. Content elements consist of the information contained in the document, such as the facts or ideas the document conveys to a recipient. Design elements, on the other hand, consist of the various ways in which the documents expresses its content, such as font choice, color schemes, logos, text size, etc. The design elements of a document do not alter the content elements expressed by the document. However, the design elements of the document will typically effect how the recipient perceives the content elements.

Typically, the system can accept design and content elements from a variety of sources including for example a database of design elements and content elements. The system can design documents based on the variety of sources and a set of output criteria. Output criteria can include limits on size, cost, format (e.g. text only, text plus graphics, video, multimedia, etc.), or any other limits chosen for the output.

The system tests output documents for a variety of factors by allowing for feedback from intended recipients of a document about the design and content of the document. The feedback may be in any form, such as a survey, or the number of recipients who respond to an advertisement, or the amount of time it takes the recipient to read a web page, for example. In this way the system correlates the response of recipients to the design and content elements of the document. Any correlations that are established through testing the response of recipients can be used as a basis for creating new documents or modifying the design and content elements of an existing document.

Furthermore, the system can take an existing document as an input. The system breaks down the existing document into content elements and design elements. The content and design elements can then be compared to content and design elements in the database of content and design elements. This allows the system to use known correlations between design and content elements and recipient responses in order to analyze the existing document. Once the system has analyzed the existing document the system can make recommendations for changing the existing document. Regardless of any changes made by the system, the system can begin testing the document to establish correlations between its design and content elements and responses by recipients.

Additional aspects and advantages of this invention will be apparent from the following detailed description of preferred embodiments thereof, which proceeds with reference to the accompanying drawings.

### BRIEF DESCRIPTION OF THE DRAWINGS FIG. 1 is a flowchart showing an overview of the operation of an automated document creation system in accordance with the present invention.

FIG. 2 is a flowchart showing the process of initializing the automated document creation system of FIG. 1 in greater detail.

FIG. 3 is a flowchart showing how the system of FIG. 1 generates a first document in greater detail.

FIG. 4 is a flowchart showing how the system of FIG. 1 tests the first document and establishes correlations between the design and content elements of the first document and responses of recipients to those design and content elements.

FIG. 5 is a flowchart showing how the system of FIG. 1 generates a second document based on the testing and correlation of the first document shown in FIG. 4.

FIG. 6 is a flowchart showing how the system of FIG. 1 is modified when the system determines that a second document will be generated.

FIG. 7 is a flowchart showing an alternate embodiment of the system shown in FIGS. 1-6.

### DETAILED DESCRIPTION OF PREFERRED EMBODIMENTS

FIG. 1 is a flowchart showing an overview of the operation of an automated document creation system in accordance with the present invention. With reference to FIG. 1, the first step in the process is to initialize the system (system initialization) 100. System initialization 100 involves setting any initial criteria, parameters, or initialization variables that may be necessary along with configuring the architecture of the system and determining what resources are available to the system and how best to use those resources. After the system is initialized it can generate output 101, in the form of a first document or a set of first documents (not shown). In accordance with the present invention the term document refers to any of a wide variety of outputs ranging from a printed piece of paper, as in a direct mail advertisement, to a multimedia Web page. After the system has generated output the system tests the output and correlates the test results (test and correlate) 102. The system will then, if appropriate given parameters set during system initialization 100, create more output 103. If create more output 103 is appropriate the next system will modify the system 104, which involves changing system parameters, changing the system architecture to more efficiently use available resources, and which in turn leads the system back to generate output 101, in the form of a second document or a set of second documents.

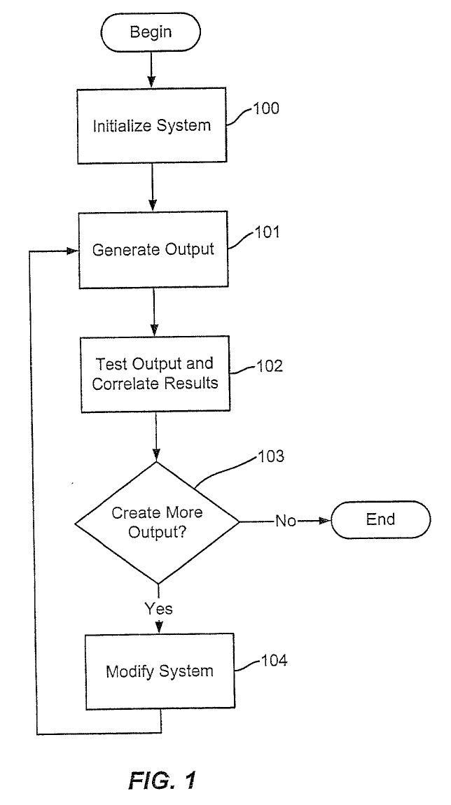

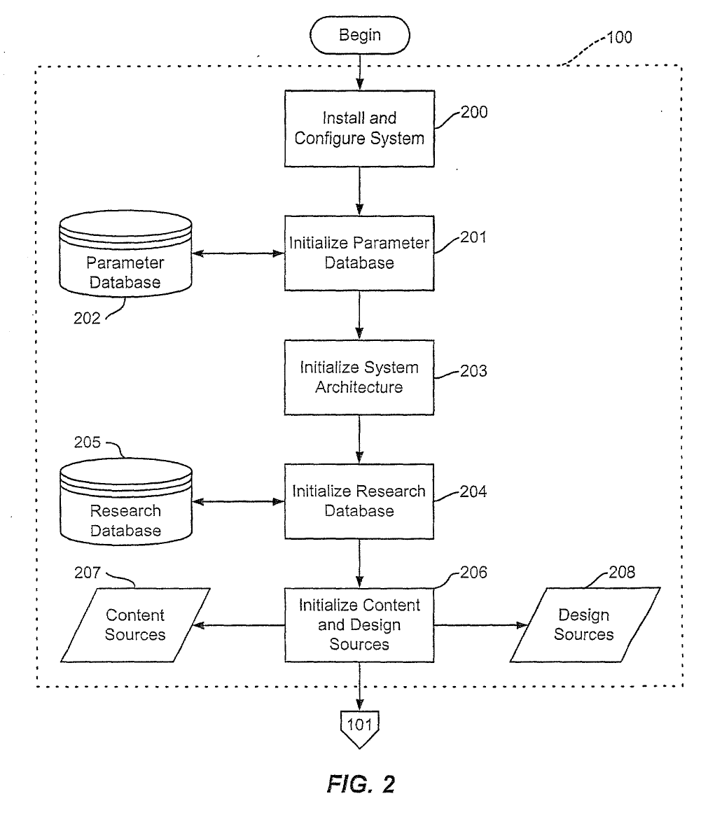

FIG. 2 is a flowchart showing the process of system initialization 100, from FIG. 1, in greater detail. With reference to FIG. 2, the first step in System initialization 100 is installing and configuring the system (install and configure) 200. Install and configure 200 involves configuring the architecture of the system, i.e. determining what resources are available to the system and where those resources are located, and setting parameters to control how the system uses the available resources. Resources in this sense include CPUs, databases, networks, etc. During install and configure 200 any required hardware for the system and network is configured for operation, in addition the system determines various system parameters such as the number of hard drives available to the system, the amount of volatile memory available to the system, the location of any necessary databases and what those necessary databases are called along with any additional information that is necessary to connect to and utilize the various resources available to the system. Install and configure 200 can be automated to some degree. However, in a presently preferred embodiment this is a separate step that may involve interaction with a system administrator or system operator.

The next step in system initialization is initializing parameter database 201. In this step a parameter database 202 is initialized, with several parameters such as those discussed above loaded into the database, and other parameters determined by a system operator, so that the system may later retrieve the various parameters from parameter database 202. The parameters affect many aspects of system functionality and behavior and may range from limitations upon inputs to the system, to limitations on outputs from the system, to ways in which the system architecture is configured. For example, parameter database 202 may be configured so that the system only uses text and static graphics for generating a document.

The term parameters includes the design, the selection of content, the mixing of content, a format in which a generated document should be output and how output is generated. Another aspect of parameter database 202 is that the various parameters describe a state of the system architecture, i.e. is the architecture is primarily an object oriented design, or is it a single processor design, or is it an integer of computation device, or is it a neural network, or is it a genetic algorithm. The parameters in parameter database 202 determine the initial population of architecture types and how the architecture is going to be used by the system. The system can in one embodiment be a plurality of architectures with said architectures running in parallel and the system choosing between which of said architectures is needed, or which of said architectures appears to be the most efficient at dealing with any particular computation. For example, if the system discovers that neural networks are more efficient with a certain computation that genetic algorithms are, then the system will send that computation to an available neural network whenever possible, or whenever doing so would improve the overall performance of the system.

Initializing parameter database 201 is followed by initializing a system architecture 203. Initializing a system architecture 203 consists of initializing the various components of the system architecture, so that the system knows where each component is located, and so that the system knows how to communicate with each component, and so that the components of the system architecture will be ready when the system needs to use them. Next the system initializes a research database 204. In initialize research database 204 a research database 205 is initialized and made available to the system. Research database 205, when initialized, may include test samples of a prior output document along with the parameters used to generate that output document and optionally a user profile including the response a particular user had to the prior output document. The test cases allow the system to take advantage of past research in determining and using correlations between design and content elements and the responses of recipients to those design and content elements, based on actual recipient responses to prior documents. Alternatively, research database 205 may at the time of initialization not include prior test cases. In that scenario the system does not have the benefit of prior research and must learn how a recipient will respond to a variety of design and content elements.

This is followed by initializing content and design sources 206. In initialize content and design sources 206 a content database 207 and a design database 208 are initialized and any design and content elements within design database 206 and content database 207, respectively, are made available to the system for designing output documents. Content and design sources may be simply databases of design and content elements, though content and design sources do not need to be so limited. Design sources 206 typically include artwork, fonts, logos, color schemes, etc. Content sources 207 typically includes various substantive information, or content elements, such as an ASCII text document, an audio stream, a video stream, photographs, data etc. Content database 207 provides the information available to the system for presentation to a recipient, while design database/sources 206 provides the available aesthetic choices for the presentation of content from content database 207 to a recipient. Typically design elements come from two sources. First there are external design elements which come from outside of the system and second are internal design elements that are generated internally by the system. In either case though, a substantial amount of initialization has to go with design database 206. Design database 206 must find all available design sources and decompose each design source into an object-oriented description and then store each description in design database 206 in a manner that allows for easily retrieving the design element from design database 206 at a later time. Similar work goes into initializing content database 207. Content sources are decomposed into object oriented descriptions and stored in a database for easy retrieval. It is possible to decompose content sources to a variety of levels, such as paragraph objects, sentence objects, and word objects. This allows the system to get down to the level of what information is actually contained in a particular content source. This can be useful for customizing the content based on knowledge of the intended recipient, such as if the intended recipient of the output document is reading at a college level or an elementary school level. The system can pick different word objects, perhaps just synonyms, or even select different sentence objects with higher or lower sentence complexity as appropriate based on the reading level of the intended recipient, so that the substantive content of the document is the same while the presentation is different depending upon the intended recipient.

Parameter database 202 stores all the settings that the system uses to generate an output document. Generating an output document includes selecting a right input, generating the output and then distributing the output. If it is desirable to make changes to the output document, then those changes are effected through changes to parameter database 202 using information from research database 205 as a basis for change in conjunction with any predetermined parameters, i.e. design choices, provided by a system operator, or in an alternative embodiment such as a web page by the intended recipient.

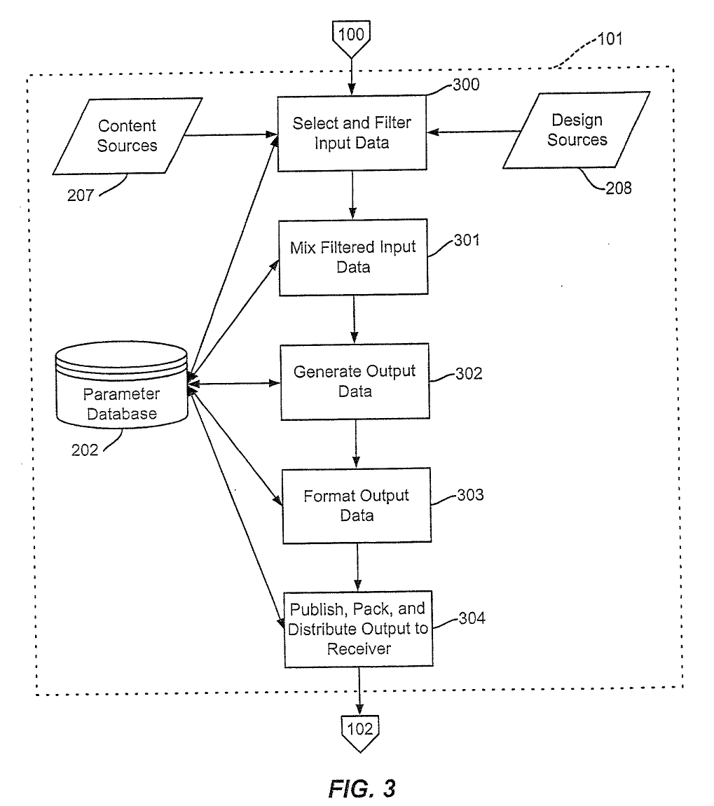

FIG. 3 is a flowchart showing generate output 101, of FIG. 1, in greater detail. The first step in generating output is to select and filter input data (select and filter) 300 based on a set of selection and filter parameters in parameter database 202. After select and filter 300 the system must mix the filtered input data (mix data) 301, based on a set of mixing parameters in parameter database 202. After mix data 301 the system will generate output data 302 based on output parameters in parameter database 202. After generate output data 302 the system will format output data 303 according to format parameters stored in parameter database 202. Finally, the system will generate an output document and distribute it to a recipient (generate and distribute) 304 based on distribution parameter in parameter database 202.

Input data typically consists of data, design and/or content elements, from content database 207. In select and filter 300 content elements and design elements, from content database 207 and design database 208 respectively, corresponding to selection and filter parameters, i.e. filtering rules, in parameter database 202, are selected for use by the system in generating an output document. Selection and filtering parameter may include, for example, content pertaining to a particular topic, or limits upon the length of the content, or limits on the format of the content. Based on a filtering parameter the system may limit the output to the first paragraph, or first page of a long content source pertaining to the appropriate subject matter in order to meet a document length requirement. Mixing parameters may include, for example, limits upon the mixture of design and content in the output document. Distribution parameters may include limits upon the overall weight of the output document, in order to meet certain postage requirements for example, or perhaps a limit upon the overall cost of the output document including materials and distribution costs.

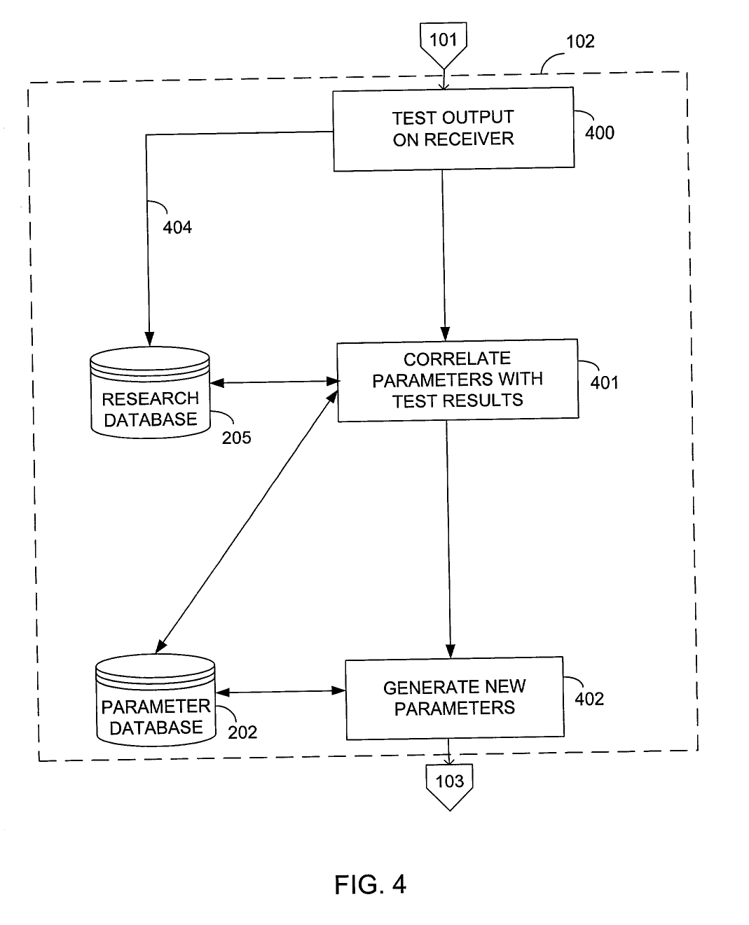

FIG. 4 is a flowchart showing how the system of FIG. 1 tests the first document and establishes correlations between the design and content elements of the first document and responses of recipients to those design and content elements. Once an output document is generated in generate output 101, the next step is test and correlate 102. Test and correlate 102 allows the system to receive feedback from document recipients in order to gather information about the recipient's response to the output document. The system can for example test to determine a correlation between font width and reading time for a recipient. The system would, under these circumstance test a recipient's reading time of a first document, having design and content elements, with a predetermined font width. The system would then send the recipient a second document with all parameters the same as the first document, except the font width is wider than for the first document. In this way, over the course of several output documents, the system can establish a correlation between font width and reading speed, thus allowing the system to use this correlation when designing future documents for this recipient or for other recipients. The system uses various known techniques, these techniques include for example deduction engines, inference engines, limits testing, discontinuity detection, etc., in order to detect potential correlations. The system once it has identified a potential correlation will design tests to determine the reliability, i.e. repeatability, of the correlation, as well as design test to determine the extent of the correlation. This may include repeated tests with the same parameters and different users, to determine the correlations applicability to a broader category than an individual recipient, or repeated tests with the same parameters for the same user, or tests in which the parameter of interest is taken slowly to its own extremes in order to determine any points at which the correlation no longer hold true.

The first step in test and correlate 102 is testing the output on a receiver (test output) 400. The test may be as simple as how many recipients respond to the document, for example a direct mail advertisement. The test may also be more complicated such as testing whether or not the recipient takes a predetermined action based on the document. The system typically test for a single aspect of a recipient's response in order to create a correlation between a design or a content element and the test parameter. The results of the test are then input into research database 205. The test results can be automatically input, as in the case in which the output document is a web page, or the results may be manually entered as in the case in which the output document is a direct mail advertisement.

Once the system has the test results it uses those results to determine correlations between recipient responses and document parameters as well as to formulate further tests to verify, clarify or determine the extent of already identified correlations(correlate test results 401). These correlations are typically stored in research database 205 and communicated to and from the system during test output 400 and test and correlate 401. Established correlation are then used by the system to generate new parameters 402 and new parameters are stored in parameter database 202 for use in generating future output documents. Over time the system establishes statistically valid correlations between individual document parameters and past responses of recipients to the individual document parameter. In this way the system is able to learn because once a correlation has been established that correlation may be used by the system in the process of creating more output documents. Future output documents, having document parameters, design and content elements, with known correlations to recipient responses will be more effective with those recipients than the simple trial and error process typical of current document design methods.

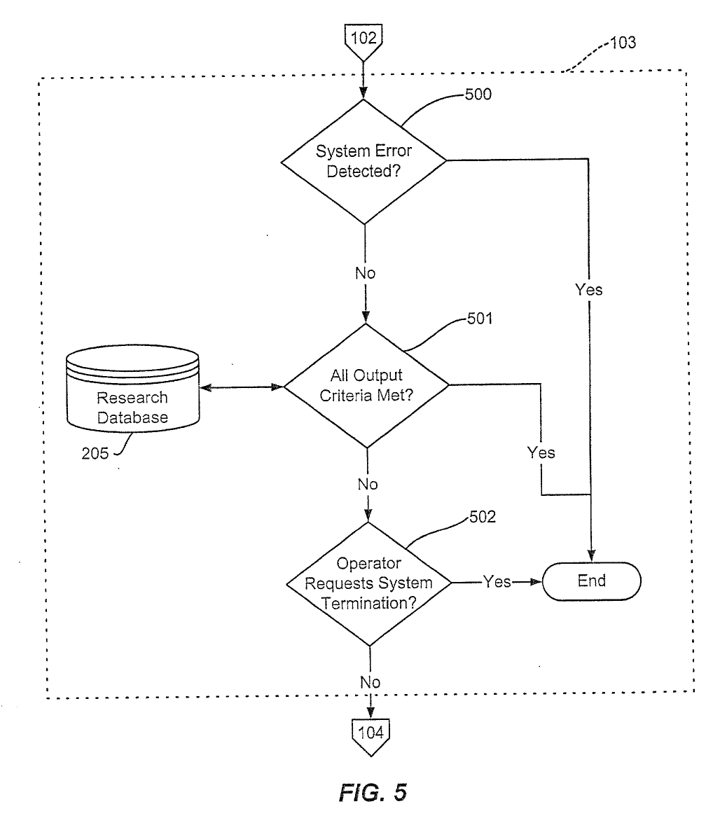

FIG. 5 is a flowchart showing how the system of FIG. 1 determines whether or not to generate more output (create more output 103) based in part on test and correlate 102, as described with reference to FIG. 4. The system is now ready to create the next generation of output documents. This is also, however, a good point to determine whether the system has met any of a set of predetermined termination conditions, which typically are termination parameters within parameter database 202. The first step at this point is to determine if any system error conditions are present, this is system error detected 500. If the system is experiencing one of a predetermined set of critical error conditions then the system will terminate. Examples of critical error conditions include the system being out of volatile memory, the system being out of hard drive space, the test results for the previously generated document were all zero. Essentially system error detected 500 is an automated integrity check of the system to ensure that the system is functioning properly and that any subsystems of the system are also functioning properly. If a system error is detected it goes to an end condition and either reports it to the operator and stops, or the system performs a diagnostic self test to determine the cause of the error condition. Alternatively, if all output criteria are satisfied (output criteria met) 501 then the system will communicate with research database 205 to determine whether any predetermined goals, in terms of document testing have been achieved by the previously output document. These conditions can include such things as the number of documents the system is supposed to produce, or a limit upon the number of variations in design and content elements that the system is supposed to test. If all predetermined output criterion are satisfied, or if the system has reached one of a set of alternative end conditions, or if a system operator requests that the system terminate (operator requests system termination 502) then the system will stop generating further output documents and wait for input from the system operator. This provides a system operator override to terminate the system before any predetermined end conditions have been satisfied.

Alternatively the intended recipient may be able to invoke an override to terminate the system. For example the system may be set up to continue generating output documents for the intended recipient until the recipient tells the system to stop. A practical example of this scenario is a web site where the recipient can tell the system to stop producing alternative design choices once the system has provided an acceptable design. In a presently preferred embodiment of the system determining if system termination conditions have been met is a shared distributed responsibility between a system operator and the intended recipient of the output documents, so that either or both may cause the system to stop generating new designs and/or content for output documents intended for that particular recipient.

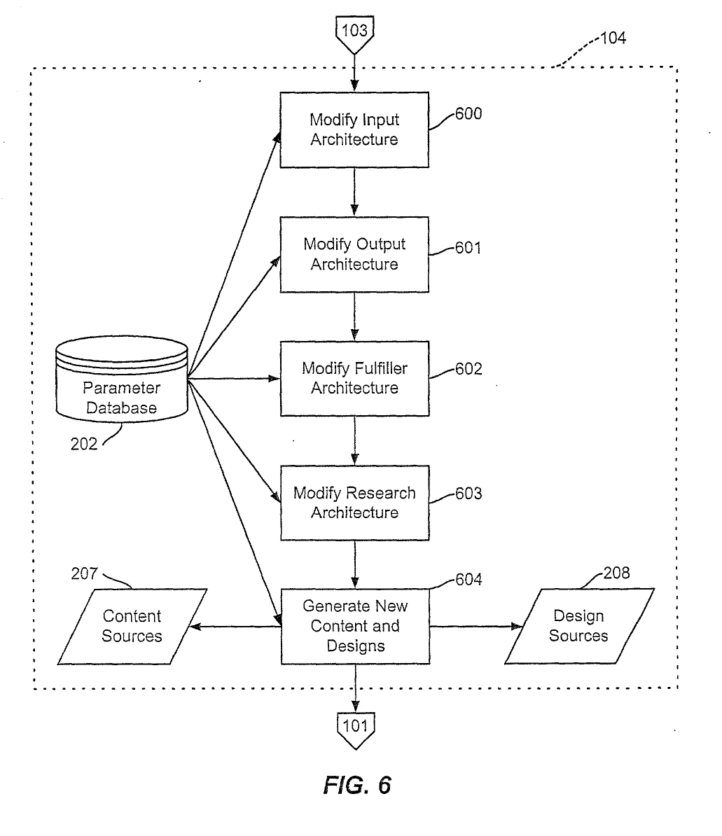

FIG. 6 is a flowchart showing how the system of FIG. 1 is modified when the system determines that additional documents will be generated. If in create more output 103 the system determines that it will continue to generate new output documents then a set of new parameters for generating the next document have already been determined during generate new parameters 402. Now the system will modify input architecture 600 to incorporate any changes to the system architecture necessitated by the set of new parameters. System architecture here refers to modifying the system architecture to potentially specify alterations to the basic operation of the system, the way that any system resources are allocated, the way that the data is collected and used, the way that the data storage is structured, as well as specific settings, configurations, database initializations, and parameters that specify things like whether to pick Arial or Helvetica font. Modify input architecture 600 includes modifying the adaptive hybrid plurality of input selectors and filters as well as setting specific choices for parameters such as font choice, color, positioning of elements, etc. The system typically uses an adaptive, hybrid plurality of methods. This means that for example during a first run of the system the system may use both a random number generator, a neural network and a genetic algorithm running in parallel and all trying to complete the same calculation. In this way the system determines which resources are more efficient for which tasks and becomes more efficient. Modify input architecture 600 allows the system to be modified based on this research and implement the changes necessary to reflect the efficiencies of various system resources.

Next the system will modify output architecture 601. Modify output architecture 601 deals with the subsystem responsible for generating output documents. Modify output architecture provides the system with additional instructions on how to filter, mix, and format an output document. It may also make code optimizations the language used as a container and scripter for design and content elements, which in a presently preferred embodiment is an XML-like meta language. For example the system may determined that its compiler is operating as a performance bottleneck, i.e. the compiler is too slow for optimal system operation. Modify output architecture 601 is an opportunity for the system to modify its compiler, for example by changing the system resources allocated to the compiler.

Modify fullfiller architecture 602 refers to the architecture for publishing, packaging and distributing the generated output document. For example this would allow the system to modify the form in which the document is output, such as switching from a zip archive to a self extracting archive for a multimedia file on a Web page, or for output that is printed material such as a direct mail advertisement then the system could switch from a third class mailing envelope to an overnight mail envelope.

Next the system may modify research architecture 603. Modify research architecture 603 includes any types of new testing methodologies that maybe beneficial to incorporate into the system such as instructing the system to start gathering information on individual users in order to create user profiles. Modify research architecture 603 may also refer to an implementation structure inside of the research subsystem such that for example the system must determine that a correlation is above a predetermined degree of certainty before it will be used to modify parameters controlling document generation, or that a correlation appear to have a predetermined accuracy before the system can use its resources to examine the correlation.

This is an opportunity for the system to reconfigure itself to more efficiently use system resources. For example, if the system determines that neural nets are used a lot in the input selection process then this is an opportunity for the system to make architectural changes so that the system supports neural net simulations more efficiently.

Next the system will generate new content and designs 604. This step allows the system to create new raw content and new raw designs. This provides the system an opportunity to generate new design elements such as new fonts, and new content elements such as new stories or new word usages. The new designs and content can then be deployed, tested and evaluated by the system.

In an alternative embodiment the system may start with an existing document which is input into the system, either through scanning and optical character recognition or what ever means are appropriate to convert the document to a computer readable format. In this embodiment the system will decompose the existing document into a set of design and content elements. The system can then compare these design and content elements with design and content elements having known correlations to user responses. Based on this comparison the system can suggest alterations to the existing document in order to improve recipient response to an updated version of the document. The document can also be used as a starting point for the system to test and determine correlations prior to modifying the document based on accumulated research.

Typically, within content database 207 and design database 208 is a subversion of the overall system of the present invention. Content database 207 and design database 208 receive input from the system of the present invention and organize the input, as well as performing research on the input design and content elements respectively. Content database 207 and design database 208 output the input design and content elements to the document creation system of the present invention. In essence, the document creation system has a similar system, that learns and improves over time, providing information and design and content elements to the system. This hierarchical structure simplifies the design of the system and provides flexibility to design the system to meet a predetermined need. By constructing the system with independent modules it can be customized to a particular application. For example, if the system is creating financial statements it may be desirable to have creativity with regards to design elements, yet at the same time undesirable for the system to have creativity with regard to content elements. The system is similar at each level of specificity, meaning each sub-system, such as research database 205, parameter database 202, content database 207 and design database 208, has a similar architecture and functional structure as the overall system. In a preferred embodiment the system is a fractal or holographic design, meaning that the system is object oriented and descriptions of the functionality at a high level of the overall system apply equally to the functionality of lower level subsystems, and vice-versa. The system is hierarchical, while also having pier-to-pie communication between subsystems at the same level in the hierarchy.

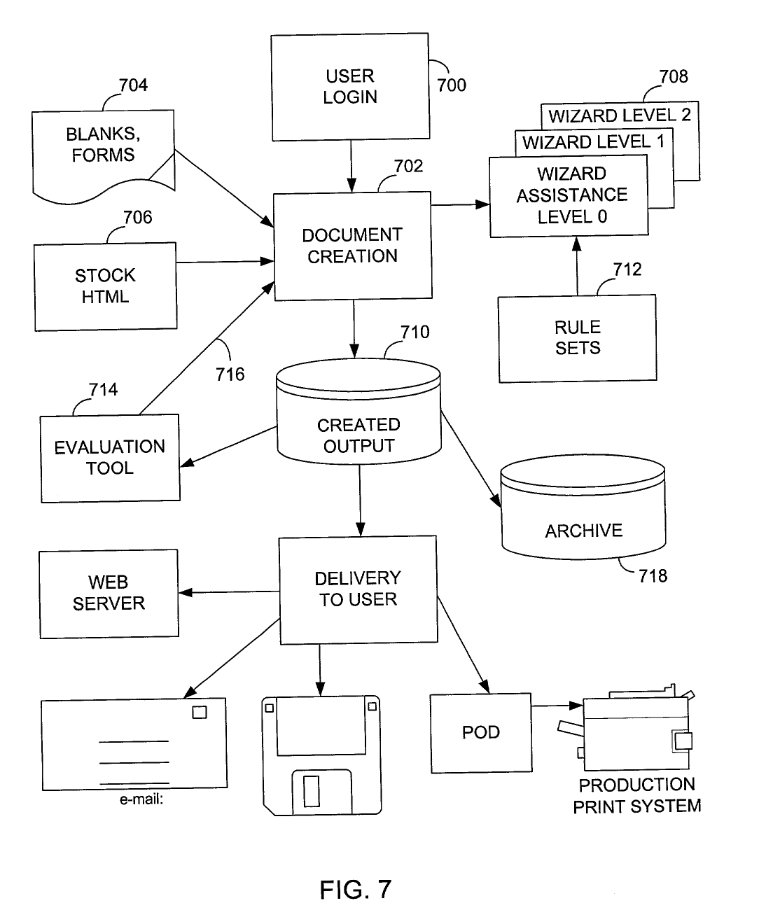

FIG. 7 illustrates one application of the methodologies described with reference to FIGS. 1 through 6. The methodologies of FIGS. 1 through 6 can be used to develop a database, i.e., to acquire knowledge over time of those particular features and characteristics of a document that are most effective. In other words, the goal is to assist in designing a document in a manner that is not merely aesthetically attractive but demonstrably effective in terms of the document's effect on the recipient. In this context, the term document refers broadly to any medium or combination of media transferred in any form to a recipient, including hard-copy printed documents, Web pages, etc.

The process described above with reference to FIGS. 1 through 6 develops a knowledgebase of features and characteristics of a document that are proven to be effective in use. These criteria can be used as metrics for objectively evaluating a proposed document. That knowledgebase is used to implement an evaluation tool for evaluating and rating a proposed document. Here are examples of such criteria:

Engage (The 7-second read, 4-second engage step. Where does your eye go to immediately? Is the piece easily readable? Use of graphics, white space, headers, subheads, etc., are important.)

Does the product, etc. “move” you?/Does it get your attention and hold it?

Does it surprise you?/Does it make you smile?

Do you feel interested and involved?

Are you able to tell “what is it?” and “why should I care?”

Educate (The “tell me what you're going to tell me, then tell me, now tell me what you told me” rules.)

Did you learn anything?/Did you learn something new?

Is the product, etc. communicating something to you in a unique way?

Empower (The material should motivate the reader/user to act. ex. enroll in their 401(k).)

Did the product, etc. motivate you to act?

Did it give you enough information to know what the next step is? Evolve (The next step phase, to keep learning more, empowering yourself more, etc.)

Does the product suggest the next step?

Does the product encourage you to take the next step?

This evaluation tool is a key component of an on-line system for rapidly creating, producing and delivering output in the desired form. For example, the system of FIG. 7 could be used by a business to order forms, letterhead or other printed documents. To illustrate, we imagine that a business user wants to create a summary of its employee benefits.

To begin, the user logs into an on-line (Worldwide Web) accessible service, at login step 700. The user then invokes a document creation tool 702 to begin preparing the employee benefits summary. A variety of blank templates and forms 704 is available to choose from in cases where the user prefers not to begin “from scratch.” Moreover, the blank forms 704 can include templates previously used by the same user (for example, including the company logo) to achieve a consistent look and feel. Similarly, stock Web pages or HTML code 706 can be made available on the service. The user invokes the assistance of a “wizard” 708 to assist the user in going through the steps necessary to create the desired document. Depending upon the user's individual preferences and experience, multiple wizards providing various levels of assistance can be deployed, as illustrated. Using the assistance of a selected wizard, and drawing upon blank forms or templates if appropriate, the user inputs text, graphics or other content to create a draft output documents 710. During this process, the selected wizard can draw upon an appropriate rule set from a collection of rule sets 712 that are predefined. Rule sets can be used to impose limitations or guidance on layout, color and other design elements, as appropriate to a particular job, user or customer. The knowledgebase derived from the research database described previously is reflected not only in the evaluation tool 714 but also in the rule sets 712 and the design wizards 708.

The user next invokes the evaluation tool 714, as mentioned above, to evaluate the proposed output 710, using predetermined metrics that provide guidance as to the readability and effectiveness of the proposed document. The evaluation tool provides feedback via path 716 to the user who can then modify the draft document to improve its effectiveness. Evaluation tool 714 can provide not only quantitative evaluation of the proposed piece, but also makes suggestions for changes-for example, in line spacing, fonts, etc. The revised output 710 then be evaluated once again and the feedback loop repeated, as desired by the user. Once the user is satisfied with the output, it can be saved in an archive 718 for later reuse.

The user then proceeds to specify one or more modes of delivery of the newly created piece including, for example, e-mail, machine-readable files, or the like. One option is to send the file to an automated “print-on-demand” system which, in turn, formats the document as appropriate to input it to a production printing/copying system for volume color printing. Such systems are known in the prior art, but because of their expense they generally are found only in commercial printing establishments or large businesses. In the present scenario, if the user chooses print-on-demand delivery, the documents can be produced and ready for physical delivery in a matter of minutes. Thus, the present system can be used to design, evaluate and produce professional, full-color output in near-real time

It will be obvious to those having skill in the art that many changes may be made to the details of the above-described embodiment of this invention without departing from the underlying principles thereof. The scope of the present invention should, therefore, be determined only by the following claims.

1. A computer-implemented method of automatically generating an output document for presentation to an end user comprising the steps of:
providing sources of content input material in digital form, the content input material encoding one or more of the data types raw data, text, graphics, video and audio materials;
providing a source of document designs;
identifying an intended receiver of the output document; and
filtering the content input material and the document designs responsive to the intended receiver of the output document so as to select content and design for building the output document appropriate to the intended receiver.

2. A method according to claim 1 and further comprising combining the selected content and the selected design so that the output document includes the selected content and incorporates the selected content in accordance with the selected design.

3. A method according to claim 2 wherein the output document comprises a filtered mixture of one or more text, graphic, and audio content elements, and further comprising arranging one or more of the output content elements based on a predicted responsiveness of the intended receiver to particular arrangements.

4. A method according to claim 3 and further comprising formatting the output document for delivery in a selected medium.

5. A method according to claim 4 wherein the selected medium comprises a software entity implemented using a selected markup language for interaction with the user via a browser type of computer program.

6. A method according to claim 4 wherein the output document is comprised of an ordered series of pages or frames.

7. A method according to claim 4 wherein the output document is comprised of an ordered series of audio sound segments.

8. A method according to claim 4 wherein identifying the intended receiver of the output document includes identifying at least one individual end user.

9. A method according to claim 4 wherein identifying the intended receiver of the output document includes identifying a predetermined class of end users.

10. A computer-implemented method of automatically building a research database for improving the effectiveness of an output product for presentation to an end user, the method comprising the steps of:
receiving input material in digital form, the input material encoding one or more of the data types raw data, text, graphics, video and audio materials;
identifying an intended receiver of the output product;
creating a first output product comprising the input material and having a design responsive to the intended receiver;
delivering the first output product to the intended receiver;
receiving results from the intended receiver in response to the first output product;
measuring an effectiveness of the first output product with respect to the intended receiver by comparing the received results to a predetermined criterion;
identifying a correlation between the measured effectiveness and the first output product; and
storing indicia representative of the first output product, the measured effectiveness and the intended receiver as a first test case in the research database.

11. A method according to claim 10 and further comprising:
modifying the first output product in response to the identified correlation so as to form a second output product;
delivering the second output product to the intended receiver;
repeating said receiving and measuring effectiveness steps with respect to the second output product;
storing indicia representative of the second output product, the measured effectiveness of the second output product and the intended receiver as a second test case in the research database; and
repeating the foregoing process with regard to additional output products thereby expanding the research database.

12. A method according to claim 11 and further comprising examining the expanded research database to confirm and characterize each correlation using one or more of the known automated hypothesis and experiment generation techniques including deduction engines, inference engines, limits testing and discontinuity detection.

13. A method according to claim 10 wherein the criterion comprises one of engage, educate, empower and evolve with respect to the identified receiver.

14. A method according to claim 10 wherein said creating output product includes:
identifying an intended receiver of the output product;
filtering the input material responsive to the intended receiver of the output product to form output content; wherein said filtering includes selecting a predetermined mixture of content and design elements; and
formatting the output content responsive to the intended receiver; said formatting including selecting a predetermined design and applying the selected design to the output content in accordance with a predetermined set of rules.

15. A method according to claim 10 wherein said identifying an intended receiver includes selecting an intended receiver in response to a predetermined goal of the output product.

16. A method according to claim 10 wherein said filtering step includes selecting a filtering rule based upon a predetermined characteristic of the intended receiver.

17. A method according to claim 16 wherein the characteristic of the intended receiver is her age and the filtering rule prescribes a ratio of textual content to graphic content of the output data responsive to the age of the intended receiver.

18. A method according to claim 14 wherein the characteristic of the intended receiver is her age and the formatting rule prescribes a font size for textual content.

19. A method according to claim 10 wherein said creating output product includes:
identifying an intended receiver of the output product;
determining a set of parameters associated with the intended receiver;
filtering the input material responsive to the set of parameters to form output content; and
formatting the output content responsive to the intended receiver; said formatting including selecting a predetermined design and applying the selected design to the output content in accordance with the set of parameters.

20. A method of automatically generating an output product for presentation to an end user comprising the steps of:
initializing an automated output product optimization system;
using the system, generating a first output product;
testing the first output product for effectiveness based on responses of recipients to the first output product;
modifying the system based on the results of the testing step; and
repeat the generating, testing and modifying steps to improve effectiveness of the output product.

21. A method according to claim 20 wherein said initializing step includes:
initializing a parameter database;
initializing a system architecture;
initializing a research database; and
initializing content and design sources to provide input data.

22. A method according to claim 20 wherein said generating step includes:
selecting and filtering the input data responsive a first parameters read from the parameter database;
mixing the filtered input data responsive a second parameters read from the parameter database;
preparing (generating bis) output data responsive a third parameters read from the parameter database;
formatting the output data responsive a fourth parameters read from the parameter database; and
delivering the formatted output data as an output product to the intended receiver.

23. A method according to claim 20 wherein said testing step includes:
receiving test results from the intended receiver; and
correlating the test results to selected parameters.
